(19) United States
(12) Patent Application Publication
(10) Pub. No.: US 2026/0009954 A1
(43) Pub. Date: Jan. 8, 2026

(54) OPTICAL-FIBER CONNECTOR

(71) Applicant: ADVANCED-CONNECTEK INC., New Taipei City (TW)

(72) Inventors: Shu-Fen Wang, New Taipei City (TW); Kuan-Lin Chen, New Taipei City (TW); Hou-Bin Lin, New Taipei City (TW); Ta-Teh Meng, New Taipei City (TW); Jun Liu, New Taipei City (TW); Hui-Bo Chen, New Taipei City (TW); Qing-Feng Liu, New Taipei City (TW)

(21) Appl. No.: 19/258,426

(22) Filed: Jul. 2, 2025

Related U.S. Application Data
(60) Provisional application No. 63/667,900, filed on Jul. 5, 2024.

(51) Int. Cl. G02B 6/38

(52) U.S. Cl. CPC G02B 6/3897; G02B 6/3817; G02B 6/3886

(57) ABSTRACT

An optical-fiber connector includes a main body, an upper cover coupled to the main body, a circuit board, terminals, a first cushioning member on the circuit board, an optical-fiber module on the first cushioning member, magnetic attraction members, and a cable component. The circuit board is in an accommodation space of the main body. The terminals are on the circuit board and connected to contacts of the circuit board. A first surface of the optical-fiber module protrudes beyond an outer surface of the upper cover. The magnetic attraction members are on the circuit board and adjacent to the upper cover. The cable component includes power transmission wires and optical-fiber cables. The power transmission wires are connected to the circuit board and electrically connected to the terminals, and the optical-fiber cables are connected to the optical-fiber module.

### CROSS-REFERENCE TO RELATED APPLICATION

This application claims the benefit of U.S. provisional application Ser. No. 63/667,900, filed on Jul. 5, 2024, the entire contents of which are hereby incorporated by reference.

### FIELD OF THE INVENTION

The instant disclosure relates to a connector, and more particular to an optical-fiber connector.

### BACKGROUND

HDMI (High-Definition Multimedia Interface) is a connector interface of a display. The connector interface includes a board-end connector and a cable-end connector which are mated with each other. The board-end connector has an insertion cavity as well as upper and lower terminals in the insertion cavity. Moreover, as known to the inventor, the board-end connector mostly adopts metal wires for signal transmission.

As known to the inventor, the cable end connector with an HDMI interface mostly adopts metal wires for signal transmission, the intensity of the signal is attenuated in accordance with the increase of the wire length; for example, when the length is more than 10 m, the image quality and the audio performance will be severely affected. Moreover, because of the configuration of the insertion cavity at the board-end connector with the HDMI interface, after a long-term use, loose contact issue may occur easily.

### SUMMARY OF THE INVENTION

In view of these, some embodiments of the instant disclosure provide an optical-fiber connector which adopts optical fibers for signal transmission. Moreover, according to one or some embodiments, the optical-fiber connector can perform long distance (more than 10 m) lossless signal transmission, and the loose contact issue occurred after long-term use can be prevented, thereby improving the currently encountered problems for the connectors known to the inventor.

According to some embodiments of the instant disclosure, an optical-fiber connector is provided. The optical-fiber connector comprises a main body, an upper cover, a circuit board, a plurality of terminals, a first cushioning member, an optical-fiber module, a plurality of magnetic attraction members, and a cable component. The main body has an accommodation space. The upper cover has a through hole. The main body is coupled to the upper cover. The circuit board is in the accommodation space and comprises a plurality of contacts. The terminals are on the circuit board, and each of the terminals is connected to a corresponding one of the contacts. The first cushioning member is on the circuit board. The optical-fiber module is on the first cushioning member and corresponds to the through hole. A first surface of the optical-fiber module protrudes beyond an outer surface of the upper cover. The magnetic attraction members are on the circuit board and adjacent to the upper cover. The cable component comprises a plurality of power transmission wires and a plurality of optical-fiber cables. Each of the power transmission wires is connected to the circuit board and electrically connected to a corresponding one of the terminals, and each of the optical-fiber cables is connected to the optical-fiber module.

According to some embodiments of the instant disclosure, the optical-fiber connector further comprises a plurality of second cushioning members between the circuit board and the magnetic attraction members.

According to some embodiments of the instant disclosure, the optical-fiber connector further comprises a third cushioning member between the circuit board and the main body.

According to some embodiments of the instant disclosure, the main body comprises a plurality of first aligning portions, the upper cover further comprises a plurality of first mating portions, and each of the first aligning portions is coupled to a corresponding one of the first mating portions.

According to some embodiments of the instant disclosure, the main body comprises a plurality of second aligning portions, the upper cover further comprises a plurality of second mating portions, and the circuit board further has a plurality of notches. Each of the second aligning portions is coupled to a corresponding one of the second mating portions, and each of the second aligning portions passes through a corresponding one of the notches.

According to some embodiments of the instant disclosure, the main body further comprises a plurality of first aligning posts, and the circuit board further has a plurality of first aligning holes. Each of the first aligning posts passes through a corresponding one of the first aligning holes, each of the magnetic attraction members corresponds to a corresponding one of the first aligning posts, and each of the second cushioning members is in a corresponding one of the first aligning holes and corresponds to a corresponding one of the first aligning posts.

According to some embodiments of the instant disclosure, the main body further comprises a plurality of third aligning portions, the circuit board further has a plurality of second aligning holes, the first cushioning member has a plurality of third aligning holes, and a second surface of the optical-fiber module comprises a plurality of third mating portions. Each of the third aligning portions passes through a corresponding one of the second aligning holes, each of the third aligning holes corresponds to a corresponding one of the second aligning holes, and each of the third mating portions is coupled to a corresponding one of the third aligning portions and passes through a corresponding one of the third aligning holes.

According to some embodiments of the instant disclosure, the upper cover further has a plurality of grooves, and each of the magnetic attraction members is accommodated in a corresponding one of the grooves.

According to some embodiments of the instant disclosure, the first surface of the optical-fiber module comprises a plurality of optical-fiber contacts, and an interior of the optical-fiber module comprises a diffractive portion. A signal is adapted to be transmitted to the optical-fiber module through each of the optical-fiber cables, and the signal is adapted to be diffracted to the optical-fiber contacts of the optical-fiber module through the diffractive portion of the optical-fiber module.

According to some embodiments of the instant disclosure, the magnetic attraction members and the terminals are on a periphery the optical-fiber module.

The following detailed description, taken in conjunction with the accompanying drawings, will make any person skilled in the art easier to understand the objectives, technical contents, features, and achieved effects of the disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of an optical-fiber connector according to an exemplary embodiment of the instant disclosure;

FIG. 2 illustrates an exploded partial view of the optical-fiber connector according to an exemplary embodiment of the instant disclosure;

FIG. 3 illustrates a front schematic view of the optical-fiber connector according to an exemplary embodiment of the instant disclosure, where the upper cover of the optical-fiber connector is removed to show the relative positions of the internal components of the optical-fiber connector clearly;

FIG. 4 illustrates a perspective view of the optical-fiber connector according to an exemplary embodiment of the instant disclosure, where the upper cover of the optical-fiber connector is removed to show the relative positions of the internal components of the optical-fiber connector clearly;

FIG. 5 illustrates an exploded partial view of an optical-fiber connector according to an exemplary embodiment of the instant disclosure;

FIG. 6 illustrates a see-through perspective view of an optical-fiber connector according to an exemplary embodiment of the instant disclosure, where the main body of the optical-fiber connector is illustrated in a see-through manner to show the relative positions of the internal components of the optical-fiber connector;

FIG. 7 illustrates an exploded view showing a third cushioning member, a circuit board, a first cushioning member, a cable component, an optical-fiber module, terminals, second cushioning members, and magnetic attraction members of an optical-fiber connector according to an exemplary embodiment of the instant disclosure;

FIG. 8 illustrates an exploded view showing a third cushioning member, a circuit board, a first cushioning member, a cable component, an optical-fiber module, terminals, second cushioning members, and magnetic attraction members of an optical-fiber connector according to an exemplary embodiment of the instant disclosure;

FIG. 9 illustrates a cross-sectional view of the optical-fiber connector of FIG. 1 along line 9-9 shown in FIG. 1;

FIG. 10 illustrates an enlarged partial view of the region 10 shown in FIG. 9;

FIG. 11 illustrates a cross-sectional view of the optical-fiber connector of FIG. 1 along line 11-11 shown in FIG. 1; and

FIG. 12 illustrates a cross-sectional view of the optical-fiber connector of FIG. 1 along line 12-12 shown in FIG. 1.

### DETAILED DESCRIPTION

Various embodiments of the instant disclosure will be described in detail below and illustrated with reference to the accompanying drawings. In the description of the specification, numerous specific details are provided to enable the reader to have a more complete understanding of the instant disclosure; however, the instant disclosure may be implemented without some or all of these specific details. Identical or similar elements in the drawings will be denoted by the same or similar reference numerals. It is further noted that the drawings are provided for illustrative purposes only and do not represent the actual dimensions or quantities of the elements, and some details may not be fully drawn for the sake of simplicity.

According to some embodiments of the instant disclosure, the term “signal” refers to signals such as light, image, or sound which can be transmitted by an optical-fiber connector.

According to some embodiments of the instant disclosure, the term “optical-fiber” refers a fiber formed of glass or plastic that utilizes the principle of total internal reflection to transmit light within the fiber, acting as a light transmission tool. According to some embodiments of the instant disclosure, the term “optical-fiber cable” refers to a cable or a wire comprising optical fibers. According to some embodiments of the instant disclosure, the term “optical-fiber module” refers to a module structure comprising optical fibers.

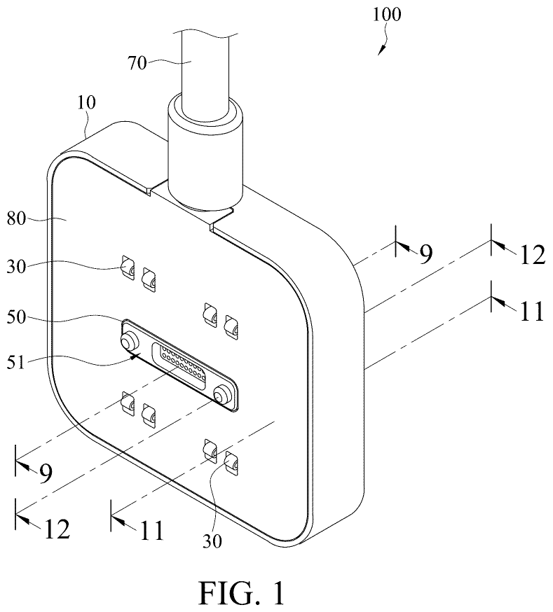

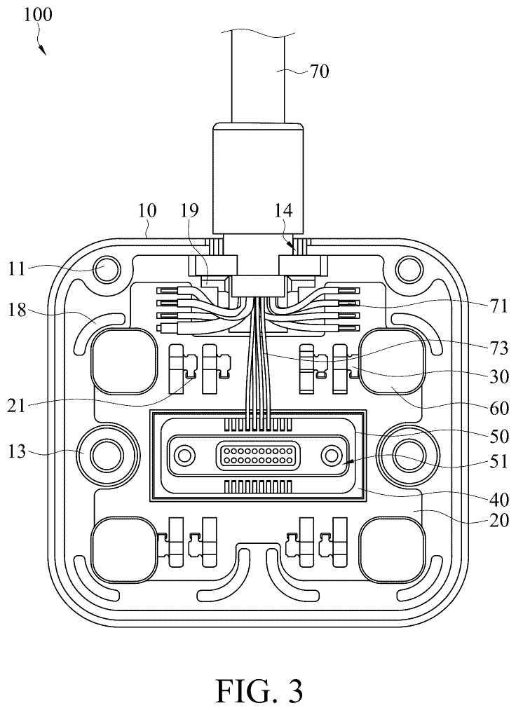

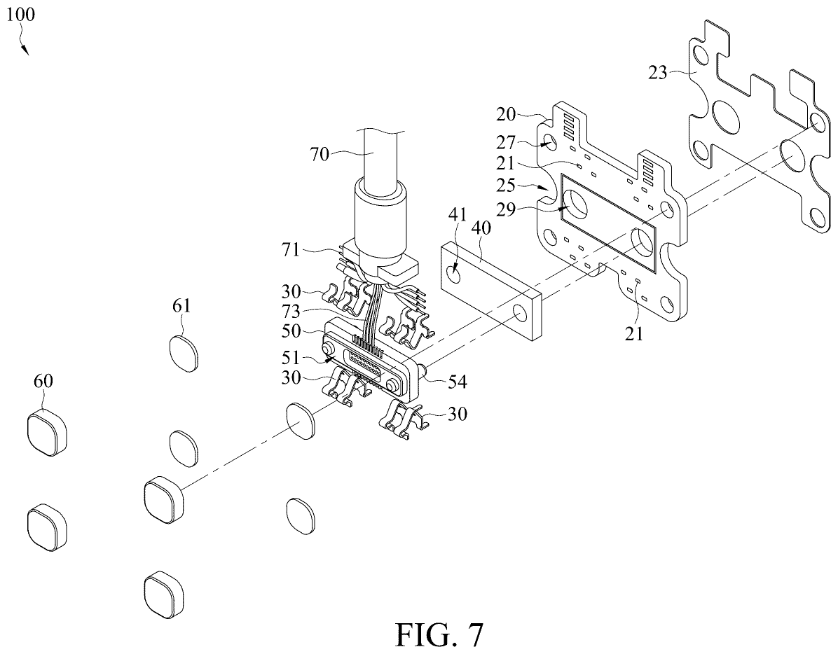

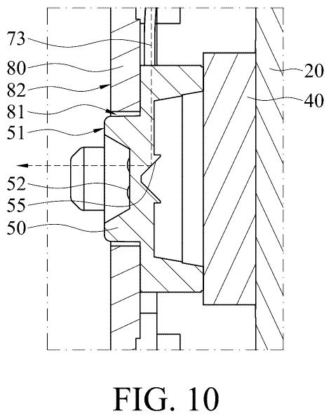

Please refer to FIG. 1 to FIG. 4, an exemplary embodiment of an optical-fiber connector 100 is illustrated. The optical-fiber connector 100 is a cable-end connector configured to be mated with a board-end connector. The optical-fiber connector 100 is used for signal transmissions in a display. The optical-fiber connector 100 comprises a main body 10, an upper cover 80, a circuit board 20, a plurality of terminals 30, a first cushioning member 40, an optical-fiber module 50, a plurality of magnetic attraction members 60, and a cable component 70. The main body 10 has an accommodation space A. The upper cover 80 has a through hole 81. The main body 10 is coupled to the upper cover 80. The circuit board 20 is disposed within the accommodation space A. The first cushioning member 40 is on the circuit board 20. The optical-fiber module 50 is on the first cushioning member 40 and corresponds to and aligned with the through hole 81. The magnetic attraction members 60 are mounted on the circuit board 20 and adjacent to the upper cover 80. The cable component 70 comprises a plurality of power transmission wires 71 and a plurality of optical-fiber cables 73. Each of the power transmission wires 71 is connected to the circuit board 20 and is electrically connected to a corresponding one of the terminals 30, and each of the optical-fiber cables 73 is connected to the optical-fiber module 50. Please refer to FIG. 7. The circuit board 20 comprises a plurality of contacts 21, and each of the terminals 30 is on the circuit board 20 and connected to a corresponding one of the contacts 21. Please refer to FIG. 10, a first surface 51 of the optical-fiber module 50 protrudes beyond an outer surface 82 of the upper cover 80. The first cushioning member 40 can provide a cushioning function between the optical-fiber module 50 and the circuit board 20, and the first cushioning member 40 can compensate the assembly tolerances of the optical-fiber connector 100. Moreover, through the configuration of the magnetic attraction member 60, the optical-fiber connector 100 can enable to magnetically align and securely mate with a counterpart connector (such as a board-end connector) through magnetic attraction. Therefore, the risk of loose contact upon long-term use of the optical-fiber connector 100 and the mating connector can be prevented. Moreover, through the configuration of the optical-fiber cables 73 and the optical-fiber module 50, the signals inputted in the optical-fiber connector 100 can be transmitted through the optical fibers, so that the optical-fiber connector 100 may support long-distance (more than 10 m) lossless signal transmission. In some embodiments, the optical-fiber connector 100 may support long-distance (more than 15 m) lossless signal transmission.

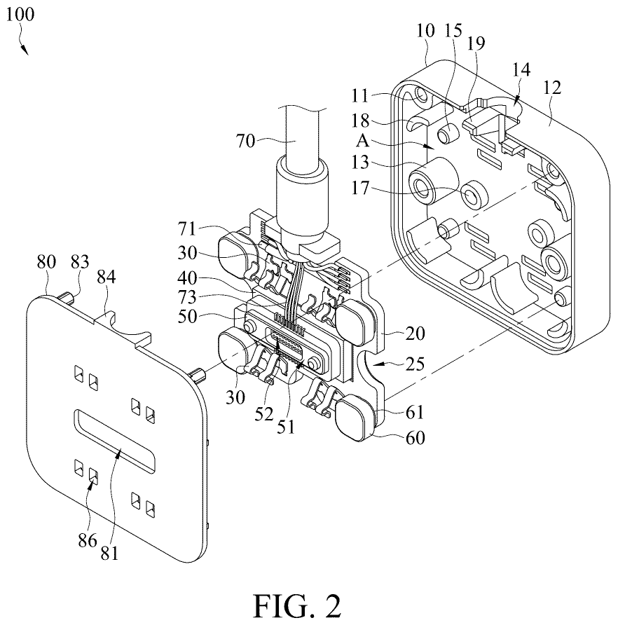

Please refer to FIG. 2 to FIG. 4. In some embodiments, after the optical-fiber connector 100 is mated with the board-end connector of the display device, the terminals 30 of the optical-fiber connector 100 come into electrical contact with corresponding contacts of the board-end connector. In this embodiment, after the current is transmitted to the terminals 30 via the power transmission wires 71 of the optical-fiber connector 100, the current is further conducted to the contacts of the board-end connector contacted by the terminals 30 of the optical-fiber connector 100 thereby supplying power to the board-end connector.

Please refer to FIG. 2 to FIG. 4. In some embodiments, the terminal 30 is formed of a conductive material; for example, the terminal 30 is formed of metal such as copper. The optical-fiber connector 100 conducts electrical power via the terminals 30 formed of metal. In some embodiments, the terminal 30 is a bent flexible terminal; for example, the terminal 30 is a resilient metal piece. In some embodiments, the terminals 30 are positioned around the periphery of the optical-fiber module 50. The number of the terminals 30 may vary depending on the current (amp) requirements for the optical-fiber connector 100. In this embodiment, the optical-fiber connector 100 comprises eight terminals 30 corresponding to eight power transmission wires 71; as long as the terminals 30 can allow the optical-fiber connector 100 to possess enough current supply, the number of the terminals 30 is not limited.

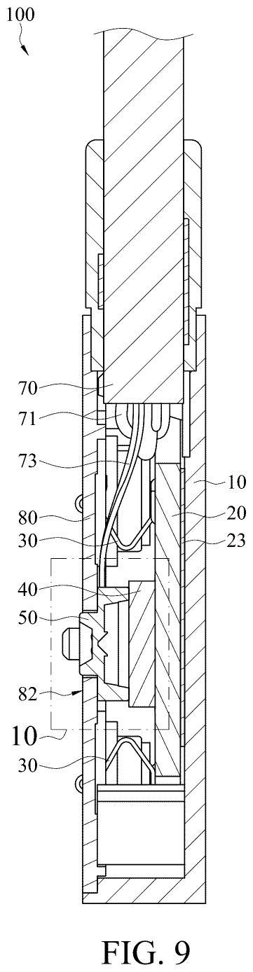

Please refer to FIG. 2 to FIG. 4. In some embodiments, the upper cover 80 further has a plurality of terminal holes 86, each of the terminal holes 86 corresponds to a corresponding one of the terminals 30, and the number of the terminal holes 86 is equal to the number of the terminals 30. Please refer to FIG. 9. At least one portion of the terminal 30 protrudes beyond the outer surface 82 of the upper cover 80. The configuration facilitates reliable electrical contact that the at least one portion of the terminal 30 protrudes beyond the outer surface 82 of the upper cover 80, the contact between the terminals 30 of the optical-fiber connector 100 and the contacts of the mating board-end connector can be achieved more conveniently. Please refer to FIG. 2 to FIG. 4.

In some embodiments, the magnetic attraction members 60 are disposed around the periphery of the optical-fiber module 50. In some embodiments, the magnetic attraction members 60 are magnets. In this embodiment, the optical-fiber connector 100 comprises four magnetic attraction members 60.

Please refer to FIG. 2 to FIG. 4 and FIG. 10. In some embodiments, the first cushioning member 40 may be formed of a foam material. The shape of the first cushioning member 40 corresponds to the shape of the optical-fiber module 50, and the first cushioning member 40 has a predetermined thickness that allows the first surface 51 of the optical-fiber module 50 to protrude beyond the outer surface 82 of the upper cover 80.

Please refer to FIG. 2 and FIG. 7. In some embodiments, the optical-fiber connector 100 further comprises a plurality of second cushioning members 61 disposed between the circuit board 20 and the magnetic attraction members 60. The shape of the second cushioning member 61 corresponds to the shape of the magnetic attraction member 60. The second cushioning member 61 provides the cushioning function between the magnetic attraction member 60 and the circuit board 20, and the second cushioning member 61 can compensate the assembly tolerances of the optical-fiber connector 100; for example, the such tolerances may arise among the upper cover 80, the circuit board 10, and the main body 10. In some embodiments, the second cushioning member 61 may be formed of a foam material, a spring, a silicone pad, or a combination thereof; in this embodiment, the second cushioning member 61 is formed of a foam material. In some embodiments, the number of the second cushioning members 61 is equal to the number of the magnetic attraction members 60, and each of the second cushioning members 61 corresponds to a corresponding one of the magnetic attractive members 60. In this embodiment, the optical-fiber connector 100 comprises four magnetic attraction members 60 and four second cushioning members 61 which correspond to each other.

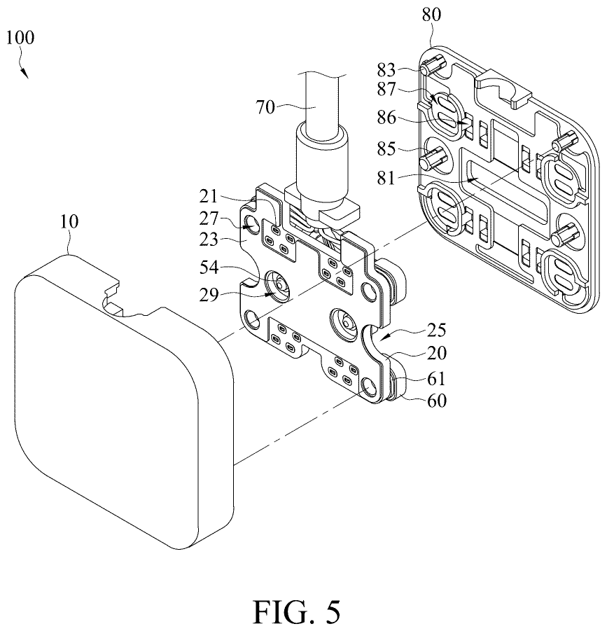

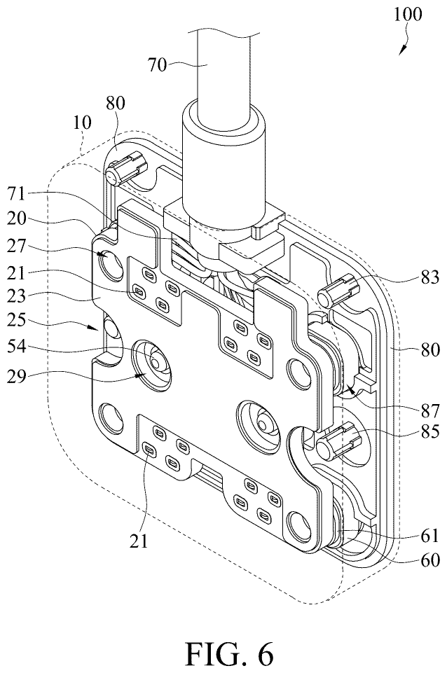

Please refer to FIG. 5 to FIG. 8. In some embodiments, the optical-fiber connector 100 further comprises a third cushioning member 23 between the circuit board 10 and the main body 10. The shape of the third cushioning member 23 corresponds to the shape of the circuit board 20. The third cushioning member 23 provides the cushioning function between the main body 10 and the circuit board 20, and the third cushioning member 23 can compensate the assembly tolerances of the optical-fiber connector 100. In some embodiments, the third cushioning member 23 may be formed of a foam material.

Please refer to FIG. 2 and FIG. 5. In some embodiments, the main body 10 comprises a plurality of first aligning portions 11, the upper cover 80 further comprises a plurality of first mating portions 83, and each of the first aligning portions 11 is coupled to a corresponding one of the first mating portions 83. As long as the main body 10 can be stably coupled to the upper cover 80, the structures of the first aligning portion 11 and the first mating portions 83 are not limited. In this embodiment, the first aligning portion 11 is a round post protruding from the main body 10 and having an insertion hole, the first mating portion 83 is a protruding post, and each of the first aligning portions 11 is mated with the corresponding one of the first mating portions 83 in a rigid interference fit, but the instant disclosure is not limited thereto. In some other embodiments, the first aligning portion 11 is a protruding post, and the first mating portion 83 is a round post protruding from the main body 10 and having an insertion hole (not shown).

Please refer to FIG. 2 and FIG. 5. In some embodiments, the main body 10 comprises a plurality of second aligning portions 13, the upper cover 80 further comprises a plurality of second mating portions 85, and the circuit board 20 further has a plurality of notches 25. Each of the second aligning portions 13 is coupled to a corresponding one of the second mating portions 85, and each of the second aligning portions 13 passes through a corresponding one of the notches 25. In this embodiment, the second aligning portions 13 is a round post protruding from the main body 10 and having an insertion hole, the second mating portion 85 is a protruding post, and each of the second aligning portions 13 is mated with the corresponding one of the second mating portions 85 in a rigid interference fit, but the instant disclosure is not limited thereto. In some other embodiments, the second aligning portion 13 is a protruding post, and the second mating portion 85 is a round post protruding from the main body 10 and having an insertion hole (not shown). Moreover, through the configuration that the second aligning portions 13 and the second mating portions 85 are coupled to the notches 25 of the circuit board 20, the circuit board 20 can be stably positioned at an expected position or a desired position of the optical-fiber connector 100, thereby preventing t wobbling and potential damage to the circuit board 20.

Please refer to FIG. 2 and FIG. 5. In some embodiments, the main body 10 further comprises a plurality of first aligning posts 15, and the circuit board 20 further has a plurality of first aligning holes 27. Each of the first aligning posts 15 passes through a corresponding one of the first aligning holes 27, each of the magnetic attraction members 60 corresponds to a corresponding one of the first aligning posts 15, and each of the second cushioning members 61 is in a corresponding one of the first aligning holes 27 and corresponds to a corresponding one of the first aligning posts 15. Therefore, through the configuration that the first aligning posts 15 pass through the first aligning holes 27 of the circuit board 20, the circuit board 20 can be reliably positioned at a desired location of the optical-fiber connector 100, so that wobbling of the circuit board 20 does not occur to prevent the damage of the circuit board 20.)

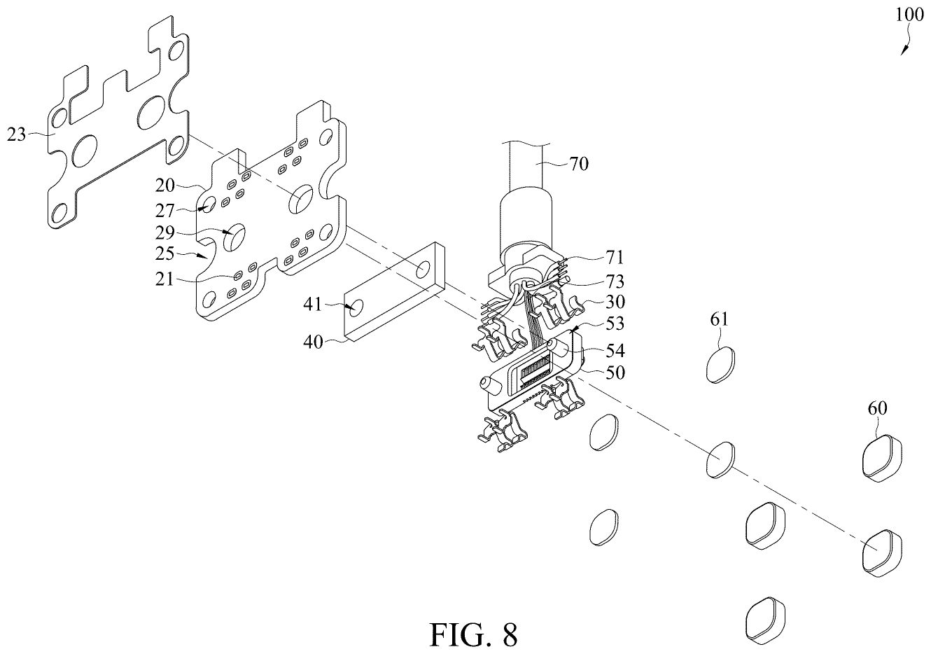

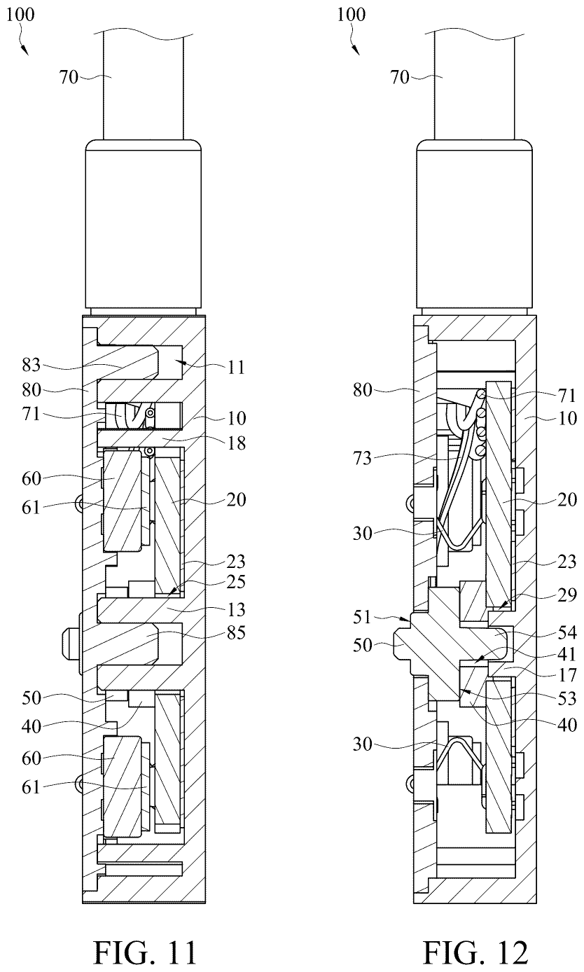

Please refer to FIG. 2, FIG. 5, FIG. 7, FIG. 8, FIG. 11, and FIG. 12. In some embodiments, the main body 10 further comprises a plurality of third aligning portions 17, the circuit board 20 further has a plurality of second aligning holes 29, the first cushioning member 40 has a plurality of third aligning holes 41, and a second surface 53 of the optical-fiber module 50 comprises a plurality of third mating portions 54. Each of the third aligning portions 17 passes through a corresponding one of the second aligning holes 29, each of the third aligning holes 41 corresponds to a corresponding one of the second aligning holes 29, and each of the third mating portions 54 is coupled to a corresponding one of the third aligning portions 17 and passes through a corresponding one of the third aligning holes 41. As long as the main body 10 can be stably coupled to the optical-fiber module 50, the structures of the third aligning portion 17 and the third mating portions 54 are not limited. In this embodiment, the third aligning portion 17 is a round post protruding from the main body 10 and having an insertion hole, and the third mating portions 54 is a protruding post, but the instant disclosure is not limited thereto. In some other embodiments, the third aligning portion 17 is a protruding post, and the third mating portion 54 is a round post protruding from the main body 10 and having an insertion hole (not shown). Moreover, through the configuration that the third aligning portions 17 and the third mating portions 54 are coupled to the second aligning holes 29 of the circuit board 20, the circuit board 20 and the optical-fiber module 50 can be stably positioned, so that wobbling of the circuit board 20 and the optical-fiber module 50 can be prevented.

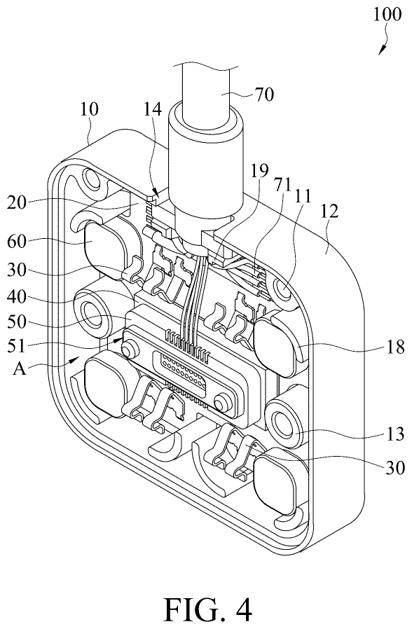

Please refer to FIG. 2 and FIG. 4. In some embodiments, the main body 10 is box-shaped, the main body 10 further has a side surface 12, and the side surface 12 has a recess 14. The main body 10 further comprises a plurality of first protruding ribs 18 and a plurality of second protruding ribs 19. The first protruding ribs 18 are on the periphery of the circuit board 20, so that the circuit board 20 can be positioned and wobbling of the circuit board 20 can be prevented. The second protruding ribs 19 are adjacent to the recess 14 and are at two sides of at least one portion of the cable component 70 for positioning the cable component 70. In some embodiments, the upper cover 80 further comprises a third protruding rib 84 corresponding to the recess 14, so that the cable component 70 is positioned in a through opening formed by the recess 14 and the third protruding rib 84. The number of the first protruding ribs 18 may vary depending on the positioning requirements for the circuit board 20. In this embodiment, the optical-fiber connector 100 comprises six first protruding ribs 18; as long as the first protruding ribs 18 can allow the circuit board 20 to be positioned properly, the number of the first protruding ribs 18 is not limited. Moreover, the number of the second protruding ribs 19 may vary depending on the positioning requirements for the cable component 70. In this embodiment, the optical-fiber connector 100 comprises two second protruding ribs 19; as long as the second protruding ribs 19 can allow the cable component 70 to be positioned properly, the number of the second protruding ribs 19 is not limited.

Please refer to FIG. 5. In some embodiments, the upper cover 80 further has a plurality of grooves 87, and each of the magnetic attraction members 60 is accommodated in a corresponding one of the grooves 87. Through the configuration that the magnetic attraction members 60 are accommodated in the grooves 87, the magnetic attraction members 60 can be positioned and wobbling of the magnetic attraction members 60 can be prevented. For example, in this embodiment, the upper cover 80 has four grooves 87 accommodating four magnetic attraction members 60.

Please refer to FIG. 2 and FIG. 10. In some embodiments, the first surface 51 of the optical-fiber module 50 comprises a plurality of optical-fiber contacts 52, and an interior of the optical-fiber module 50 comprises a diffractive portion 55. A signal (indicated as a dashed arrow in FIG. 10) is adapted to be transmitted to the optical-fiber module 50 through each of the optical-fiber cables 73, and the signal is adapted to be diffracted to the optical-fiber contacts 52 of the optical-fiber module 50 through the diffractive portion 55 of the optical-fiber module 50. Therefore, the signal can be transmitted to the board-end connector of the display in which the board-end connector is mated with the optical-fiber connector 100.

In some embodiments, the assembling of the optical-fiber connector 100 as below. The power transmission wires 71 of the cable component 70 and the terminals 30 are connected to the circuit board 20. After the third cushioning member 23 is adhered on the main body 10, the circuit board 20 connected to the power transmission wires 71 of the cable component 70 and the terminals 30 is placed on the third cushioning member 23, where the second aligning portions 13, the third aligning portions 17, the first aligning posts 15, and the first protruding ribs 18 are all helpful in positioning the circuit board 20, while the second protruding ribs 19 are helpful in positioning the cable component 70. Next, the first cushioning member 40 is placed on the circuit board 20, and the optical-fiber module 50 is placed on the first cushioning member 40. The third mating portions 54 on the second surface 53 of the optical-fiber module 50 are coupled to the third aligning portions 17 of the main body 10, so that the positioning of the optical-fiber module 50 and the circuit board 20 can be achieved properly. The magnetic attraction members 60 are adhered in the grooves 87 of the upper cover, and the second cushioning members 61 are adhered on the magnetic attraction members 60. Then, through the combination between the first aligning portions 11 of the main body 10 and the first mating portions 83 and the combination between the second aligning portions 13 and the second mating portions 85, the assembling of the optical-fiber connector 100 can be achieved.

In view of these, some embodiments of the instant disclosure provide an optical-fiber connector which can perform long distance lossless signal transmission, and the loose contact issue occurred after long-term use can be prevented, thereby improving the currently encountered problems for the connectors known to the inventor.

What is claimed is:

1. An optical-fiber connector comprising:
a main body having an accommodation space;
an upper cover having a through hole, wherein the main body is coupled to the upper cover;
a circuit board in the accommodation space, wherein the circuit board comprises a plurality of contacts;
a plurality of terminals on the circuit board, wherein each of the terminals is connected to a corresponding one of the contacts;
a first cushioning member on the circuit board;
an optical-fiber module on the first cushioning member, wherein the optical-fiber module corresponds to the through hole, and a first surface of the optical-fiber module protrudes beyond an outer surface of the upper cover;
a plurality of magnetic attraction members on the circuit board and adjacent to the upper cover; and
a cable component comprising a plurality of power transmission wires and a plurality of optical-fiber cables, wherein each of the power transmission wires is connected to the circuit board and is electrically connected to a corresponding one of the terminals, and each of the optical-fiber cables is connected to the optical-fiber module.

2. The optical-fiber connector according to claim 1, further comprising a plurality of second cushioning members between the circuit board and the magnetic attraction members.

3. The optical-fiber connector according to claim 1, further comprising a third cushioning member between the circuit board and the main body.

4. The optical-fiber connector according to claim 1, wherein the main body comprises a plurality of first aligning portions, the upper cover further comprises a plurality of first mating portions, and each of the first aligning portions is coupled to a corresponding one of the first mating portions.

5. The optical-fiber connector according to claim 1, wherein the main body comprises a plurality of second aligning portions, the upper cover further comprises a plurality of second mating portions, and the circuit board further has a plurality of notches; each of the second aligning portions is coupled to a corresponding one of the second mating portions, and each of the second aligning portions passes through a corresponding one of the notches.

6. The optical-fiber connector according to claim 2, wherein the main body further comprises a plurality of first aligning posts, and the circuit board further has a plurality of first aligning holes; each of the first aligning posts passes through a corresponding one of the first aligning holes, each of the magnetic attraction members corresponds to a corresponding one of the first aligning posts, and each of the second cushioning members is in a corresponding one of the first aligning holes and corresponds to a corresponding one of the first aligning posts.

7. The optical-fiber connector according to claim 1, wherein the main body further comprises a plurality of third aligning portions, the circuit board further has a plurality of second aligning holes, the first cushioning member has a plurality of third aligning holes, and a second surface of the optical-fiber module comprises a plurality of third mating portions; each of the third aligning portions passes through a corresponding one of the second aligning holes, each of the third aligning holes corresponds to a corresponding one of the second aligning holes, and each of the third mating portions is coupled to a corresponding one of the third aligning portions and passes through a corresponding one of the third aligning holes.

8. The optical-fiber connector according to claim 1, wherein the upper cover further has a plurality of grooves, and each of the magnetic attraction members is accommodated in a corresponding one of the grooves.

9. The optical-fiber connector according to claim 1, wherein the first surface of the optical-fiber module comprises a plurality of optical-fiber contacts, an interior of the optical-fiber module comprises a diffractive portion, a signal is adapted to be transmitted to the optical-fiber module through each of the optical-fiber cables, and the signal is adapted to be diffracted to the optical-fiber contacts of the optical-fiber module through the diffractive portion of the optical-fiber module.

10. The optical-fiber connector according to claim 1, wherein the magnetic attraction members and the terminals are on a periphery the optical-fiber module.
